(19) United States
(12) Patent Application Publication
(10) Pub. No.: US 2018/0283313 A1
(43) Pub. Date: Oct. 4, 2018

(54) Centrally Supported Piston Skirt

(71) Applicant: KS Kolbenschmidt GmbH, Neckarsulm (DE)

(72) Inventors: Klaus Lormes, Bad Wimpfen (DE); Edward Werninghaus, Bad Friedrichshall (DE)

(21) Appl. No.: 15/765,283

(22) PCT Filed: Oct. 13, 2016
(86) PCT No.: PCT/EP2016/074602

§ 371 Date: Apr. 2, 2018

(30) Foreign Application Priority Data
Oct. 13, 2015 (DE) 10 2015 219 832.4

(51) Int. Cl. F02F 3/02

(52) U.S. Cl. CPC F02F 3/02

(57) ABSTRACT

A piston for an internal combustion engine including a piston head having supporting skirt wall sections which are arranged on the bottom side of the piston head. Connecting walls extending from a pin boss are connected to the skirt wall sections in a central zone of the skirt wall which is in the form of a segment of a circle.

### FIELD OF INVENTION

The invention concerns a piston of an internal combustion engine.

### BACKGROUND

Previously, the skirt elasticity has been set by the skirt wall thickness and the inner shape of the piston. Often, high skirt wall thicknesses are required here, which leads to a high piston mass.

In known pistons, the skirt elasticity has already been created by the connection of connecting walls to the outer side edges of the supporting skirt wall portions of the piston skirt. The objective is to ensure a very high strength of the supporting skirt wall portions, without being too stiff to achieve the desired elasticity of the piston skirt which is necessary in operation of the piston in the internal combustion engine. It has already been considered to form the connecting walls, which start from the pin boss and extend in the direction of the outer supporting skirt wall portions, so as to run straight in their course parallel to the piston stroke axis or curved (e.g. convexly or concavely relative to the piston stroke axis), in order firstly to ensure a very high stiffness but secondly to also allow the necessary elasticity of the skirt wall portions. In such pistons, also called box pistons or box design, the supporting skirt wall portions are always connected at their side edges to the end of the connecting walls which extend in the direction of the pin boss. This side edge may also run straight or curved in its course parallel to the piston stroke axis.

These known pistons indeed have a satisfactory skirt elasticity in operation of the piston in the internal combustion engine, but there is still a desire to improve this skirt elasticity.

### SUMMARY

The object of the invention is therefore to create a piston which has a controllable skirt wall elasticity with use of less material.

According to the invention, it is provided that the connecting walls are connected in a central zone of the skirt wall portion relative to the shape of the supporting skirt wall portion forming a portion of a circle. This deviates from the known fundamental concept of connecting the connecting walls to the side edges of the supporting skirt wall portions in pistons of box design. It has been found, surprisingly, that if the connecting walls are connected in a central zone of the supporting skirt wall portions, the skirt elasticity can be set substantially better. It has also been found that, on reducing the material thickness of the connecting walls and/or the supporting skirt wall portions, because of this connection, the necessary strength of the piston skirt can be achieved. In this way, not only can material costs be reduced, but particularly advantageously also the weight of the entire piston. The supporting skirt wall portions which form the piston skirt lie on a portion of a circle, so that they have the form of part of a cylinder. The side edges of the supporting skirt wall portions may be configured parallel relative to the piston stroke axis, i.e. straight. They may also have a different shape relative to the piston stroke axis, such as an arcuate or multiple arcuate shape (wave-like).

There are several possibilities for attaching the connecting walls in a central zone of the associated supporting skirt wall portions.

Firstly, according to the invention it is provided the connecting walls are connected jointly to the supporting skirt wall portion in the central zone. This means that the connecting walls, starting from the respective pin boss, are oriented in the direction of the supporting skirt wall portion such that their ends which transform into the skirt wall portion run together, and hence the end regions of the connecting walls transform jointly into the supporting skirt wall portion, i.e. are connected thereto, the region of the middle thereof.

Secondly, in a refinement of the invention, it is possible that the connecting walls are connected to the supporting skirt wall portion spaced apart from each other around the central zone. This means that the connecting walls, here again starting from their respective associated pin boss, are oriented in the direction of the skirt wall portion, wherein however their ends are not connected thereto jointly but spaced about an axis (parallel to the piston stroke axis) which runs through the supporting skirt wall portion.

These two different ways of connecting the connecting walls each individually have the advantage that different skirt elasticities can be set optimally, in particular depending on load (in particular combustion pressures) of the piston, but also in relation to its remaining design.

When the piston is produced with the connecting walls connected in a central zone of the skirt wall portion, in a refinement of the invention it is conceivable that either the connecting walls are connected completely to the underside of the piston head or alternatively are connected only partially to the underside of the piston head.

Complete connection of the connecting walls to the underside of the piston head firstly has the advantage that such a piston can be produced very well in a casting process, and is reduced in weight with comparatively reduced material usage because of the connection of the connecting walls in the central zone of the supporting skirt wall portions. At the same time, the complete connection means that the piston head is very well supported in relation to the combustion pressures acting thereon.

Alternatively, to reduce weight further, it is conceivable that the connecting walls are connected only partially to the underside of the piston head. For example, in the course of the connecting wall starting from the pin boss, there is still a connection to the underside of the piston head in this region, wherein in the further course, a recess (gap or similar) is provided, and only in the last part of the course, in which the connecting wall transforms into central zone of the skirt wall portion, is there a further connection of the connecting wall to the underside of the piston head. In this way, firstly the necessary strength can be achieved (support of the piston head against combustion pressures), but an additional weight saving can also be made without significant strength losses.

The invention is explained and described below in more detail with reference to exemplary embodiments.

### BRIEF DESCRIPTION OF THE DRAWINGS

FIG. 1 is a bottom view of one example of a piston;

FIG. 2 is a bottom view of an alternate example of the piston in FIG. 1; and

FIG. 3 is a partial cross-sectional view of a piston in the pin boss area.

### DETAILED DESCRIPTION

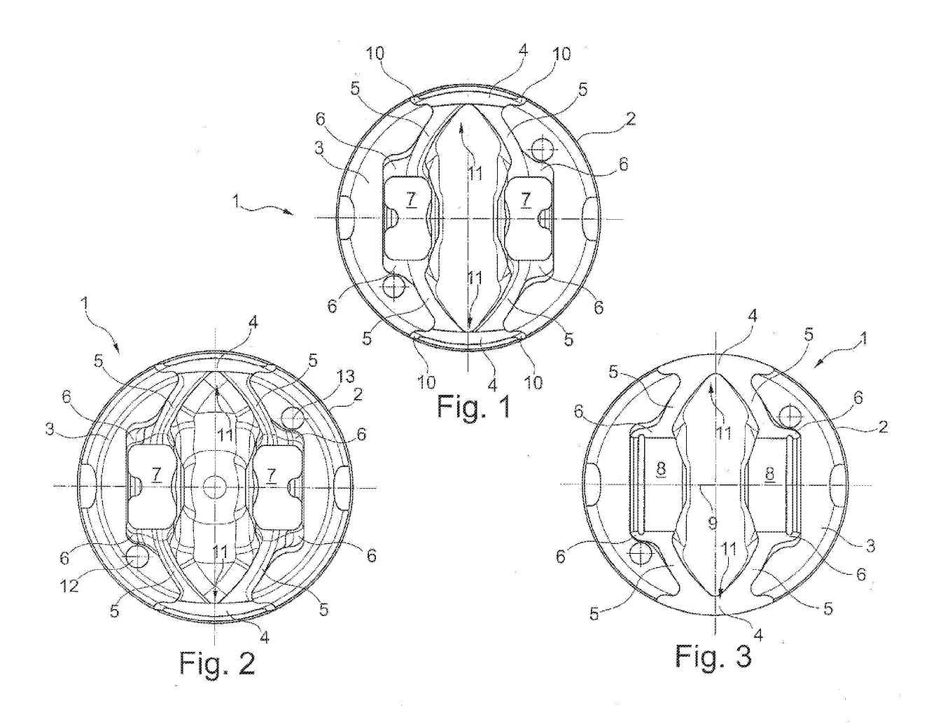

FIGS. 1 and 2 show a view from below of a piston 1, wherein a piston head 2 can be seen which has an underside 3. The piston 1 also has elements known in themselves, such as a ring zone, in some cases a combustion bowl, possibly a cooling channel and similar.

Supporting skirt wall portions 4 are arranged starting from the underside 3, via which the piston 1 is supported on the cylinder walls in operation of the internal combustion engine. The two opposing supporting skirt wall portions 4 are connected via associated connecting walls 5 which start from an associated pin boss 6. This defines the so-called box design of the piston 1, known in itself. The shape of the connecting walls 5 and the supporting skirt wall portions 4 is shown as an example in FIGS. 1 and 2, and may deviate from this with regard to course or shape, material thickness and similar.

In the view of FIGS. 1 and 2, reference number 7 designates a lower end of the pin boss 6.

FIG. 3 shows a section through the pin boss 6 which comprises a pin bore 8. Reference 9 designates a pin axis which runs through the section shown in FIG. 3.

Representatively for all Figures, reference 10 designates a side edge of the supporting skirt wall portions 4. In the prior art, the connecting walls 5 are connected to the supporting skirt wall portion 4 in the region of this side edge 10, i.e. the end of the connecting wall 5 pointing in the direction of the skirt wall portion 4 transforms into the skirt wall portion 4 in the region of the side edge 10 in the piston known from the prior art.

In contrast, here the connecting walls 5 are oriented in the direction of the skirt wall portions 4 so that they transform into these in a central zone 11 of the skirt wall portion 4.

FIGS. 1 to 3 show that the connecting walls 5 are connected to the supporting skirt wall portion 4 spaced apart from each other around the central zone 11. Alternatively however, it is also conceivable that the end regions of the connecting walls 5 are connected jointly to the supporting skirt wall portion 4 in the central zone 11. Although the latter is also conceivable, the preferred design is shown in the exemplary embodiment according to FIGS. 1 to 3, since this allows optimum setting of the elasticity with, simultaneously, the necessary stiffness of the supporting skirt wall portions 4.

If the piston 1 is configured as a cooling channel piston, it comprises, in the corresponding design, in particular in annular design, a cooling channel in the piston head 2 in which a coolant can circulate. The coolant is injected via a supply opening 12 on the underside 3 of the piston head 2; it can circulate via the cooling channel and emerge via an outlet opening 13 also on the underside 3 of the piston head 2.

FIGS. 1 and 2 differ with regard to the interior region which is formed between the pin bosses 6 and the supporting skirt wall portions 4.

In FIG. 1, the connecting walls 5 are formed so as to be almost vertical, and transform almost vertically into the piston head 2 on the underside 3, in some cases with the addition of a transitional radius.

In FIG. 2, the connecting walls 5 are sloping, and a larger radius region (compared with FIG. 1) is present, in the course along the connecting walls 5 parallel to the piston stroke axis, at the transition of the connecting walls 5 to the underside 3 of the piston head 2. In this exemplary embodiment of FIG. 2, the connecting walls 5 may run almost vertically towards the outside, parallel to the piston stroke axis, but alternatively may also be drawn inward, i.e. deviating from the course parallel to the piston stroke axis. Also, the connecting walls 5 need not have the shape shown but may also have a different shape (e.g. straight, more arcuate than shown or similar).

Due to the centrally supported piston skirt, an adaptive or controlled skirt elasticity is achieved. The skirt is supported by inwardly drawn box walls. The stiffness of the skirt is controlled by the position and form of the box walls.

With these measures to influence skirt elasticity, a noise improvement is achieved, friction is minimized and/or protection against scoring improved.

### LIST OF REFERENCE SIGNS

1. Piston

2. Piston head

3. Underside

4. Supporting skirt wall portion

5. Connecting wall

6. Pin boss

7. Lower end

8. Pin bore

9. Pin axis

10. Side edge

11. Central zone

12. Supply opening

13. Outlet opening

1. A piston of an internal combustion engine, comprising a piston head with supporting skirt wall portions which are positioned on an underside of the piston head and are connected to connecting walls extending from a pin boss, characterized that the connecting walls are connected in a central zone of the skirt wall portion relative to the shape of the supporting skirt wall portion forming a portion of a circle.

2. The piston as claimed in claim 1, wherein the connecting walls are connected jointly to the supporting skirt wall portion in the central zone.

3. The piston as claimed in claim 1, wherein the connecting walls are connected to the supporting skirt wall portion spaced apart from each other around the central zone.

4. The piston as claimed in claim 1, wherein the connecting walls are each continuously to the underside of the piston head from the pin boss to the supporting skirt wall portion.

5. The piston as claimed in claim 1, wherein the connecting walls are connected only partially to the underside of the piston head from the pin boss to the supporting skirt wall portion.

6. An internal combustion engine piston comprising:
a piston head having opposing skirt wall portions extending from an underside of the piston head in partial circular orientation, the skirt wall portions having a central zone positioned between opposing skirt wall portion distal ends; and
a pair of opposing connecting walls connected to and extending from the underside of the piston the piston head, the connecting walls connected to the opposing skirt wall portion central zone operable to control the elasticity of the skirt wall portions to a predetermined elasticity.

7. The piston of claim 6 wherein the opposing connecting walls intersect and connect to one another at the central zone.

8. The piston of claim 7 wherein the opposing connecting walls extend from the underside of the piston head at an angle relative to a piston stroke axis.

9. The piston of claim 7 wherein the connecting walls are continuously connected to the underside of the piston head.

10. The piston of claim 7 wherein the connecting walls and the underside of piston head define spatial openings between the connecting walls and the underside of the piston head.

11. The piston of claim 6 wherein the opposing connecting walls are laterally spaced from one another at the connection to the central zone.

12. The piston of claim 11 wherein the opposing connecting walls extend from the underside of the piston head at an angle relative to a piston stroke axis.

13. The piston of claim 11 wherein the connecting walls are continuously connected to the underside of the piston head.

14. The piston of claim 11 wherein the connecting walls and the underside of piston head define spatial openings between the connecting walls and the underside of the piston head.
